(19) United States
(12) Patent Application Publication
(10) Pub. No.: US 2008/0022935 A1
(43) Pub. Date: Jan. 31, 2008

(54) PADDING FOR PETS WITH INTEGRATED HEATING, COOLING, OR A COMBINATION OF HEATING AND COOLING

(75) Inventor: Richard Fine, Mercer Island, WA (US)

Correspondence Address: PERKINS COIE LLP;PATENT-SEA, P.O. BOX 1247, SEATTLE, WA, 98111-1247, US

(73) Assignee: Hyperion Innovations, Inc., Bellevue, WA (US)

(21) Appl. No.: 11/676,227

(22) Filed: Feb. 16, 2007

Related U.S. Application Data
(60) Provisional application No. 60/807,927, filed on Jul. 20, 2006.
(60) Provisional application No. 60/880,691, filed on Jan. 17, 2007.

(51) Int. Cl. A01K 1/035

(52) U.S. Cl. 119/28.5

(57) ABSTRACT

A portable heated or cooled pet bed, and methods and systems for using the same, are disclosed. According to various embodiments, the pet bed may be easily transportable between different locations (e.g., using a handle or by simply gripping one or more portions thereof), and are provided with cushion material to compensate for harsh (e.g., hard) resting or sleeping conditions that would otherwise be faced by a pet. According to various embodiments, the pet bed may include one or more heating and/or cooling elements such as a Peltier device.

### RELATED APPLICATIONS

This application claims the benefit of priority from U.S. Provisional Application No. 60/807,927, filed Jul. 20, 2006, and U.S. Provisional Application No. 60/880,691, filed Jan. 17, 2007, all of which are hereby incorporated by reference.

### TECHNICAL FIELD

The following relates to temperature-adjusted padding, and more particularly, portable heating and/or cooling beds for use with a variety of pet types.

### BACKGROUND

Portable beds are commonly used with domesticated pets. For example, small, cushion-like beds are often used to provide a comfortable (e.g., cushioned) place to rest or sleep, for pets such as cats and dogs, whether on a floor, a window sill, or at another location. While known types of portable pet beds are often quite versatile, most lack heating or cooling capabilities.

Existing heating pet beds are prone to unreliability, as they may experience one or more failures due to a break in the heating circuit. For example, in many pet bed products, a wire filament or similar resistive heating element is used to provide the heat to a pad. However, a single break or loss of connection in a wire or similar element can result in a complete circuit failure, thereby eliminating the heating functionality. Moreover, repairs of such breaks or losses of connection are often not feasible due to the permanent manner of construction of the pads, or are undesirably costly.

Known cooling pet beds tend to be ineffective. Some pet beds simply provide a centralized cooling plate with no mechanism to circulate cool air. Other known pet beds use ice packs, which eventually melt and need to be replaced.

Accordingly, it is desirable to provide improved heating or cooling beds for pets.

### SUMMARY

Heated or cooled pet beds, and methods and systems for using the same, are disclosed. According to various embodiments, these beds may be easily transportable between different locations (e.g., using a handle or by simply gripping one or more portions thereof), and are provided with cushion material to compensate for harsh (e.g., hard) resting or sleeping conditions that would otherwise be faced by a pet.

According to various preferred embodiments, the portable pet beds may include one or more heating and/or cooling elements. These heating and/or cooling elements may be based on thermoelectric principles, such as a Peltier device. Cooling may be achieved by use of a plate located in the pet bed. Dissipation of heat from the cooling element may be achieved by a fan. In some embodiments, a circuitous tubing or ducting path is present within a pad area upon which the animal rests and air is circulated through the path and recycled through a cooling element to cool the underside of an animal. In other embodiments, the coolers function with a fan to blow cold air directly onto an animal resting upon the pet bed. Alternatively and additionally, the Peltier device may also be used similarly to heat the pet bed.

In accordance with various preferred embodiments, the pet pad heating and cooling functions may be enabled using one or more portable power sources (e.g., rechargeable and/or disposable batteries), an AC power outlet, and/or a DC automobile power source (e.g., lighter plug). When one or more batteries are being used, they may be situated, e.g., internal to the cushioned portion of the pad, or attached to the exterior thereof. According to various embodiments, the heat and/or cold settings of the one or more elements are controlled by one or more power switches, temperature controlled switches, open or closed loop temperature regulators, pressure push switches, sensor switches, and/or fuse circuits. Moreover, a lighting element may also be used to indicate to a user when the heating function is being used and/or when the power source (e.g., one or more batteries) is running low on power. A cutoff circuit may also be used to deactivate the heating and cooling functions when the power level of the power source is determined to be below a certain threshold level.

According to various embodiments, a controller may be included. The controller may control the activation of one or more heating or cooling elements or both. The temperature control may use methods known in the art for activating the heating and cooling elements, such as pulse width modulation. The controller also may include an integrated circuit controller (microcontroller). Additionally, the controller may disconnect current from the heating and/or cooling elements when a sensor indicates there is no animal present, when voltage supplied from the power source is below a certain threshold, or on other pre-selected conditions. Furthermore, according to various embodiments, any electronics, such as a controller or control panel, being used may be fully enclosed in a pad such that it may be used as a standalone unit, e.g. when it is not desired to also use a frame.

According to various embodiments, a portable heated and/or cooled pet pad is used in conjunction with a frame that retains the heating and/or cooling pad in place. The portable pad (and optional frame) may be used in a variety of settings, and may be used to compensate for external temperatures or simply to attract a pet.

### BRIEF DESCRIPTION OF THE DRAWINGS

Additional embodiments will be more apparent upon consideration of the following detailed description, taken in conjunction with the accompanying drawings, in which like reference characters refer to like parts throughout, and in which:

FIG. 1A illustrates an embodiment of the pet bed with a channeled cushion

FIG. 1B provides an isometric view of the channeled cushion of the embodiment of FIG. 1A without its covering.

FIG. 1C provides a top view of the channeled cushion of the embodiment of FIG. 1A without its covering.

FIG. 1D provides an isometric view of the channeled cushion of the embodiment of FIG. 1A with its covering.

FIG. 1E provides an isometric view of one side of the cooling and/or heating device and stiffeners of the embodiment of FIG. 1A.

FIG. 1F provides an isometric view of a side of the cooling and/or heating device and stiffeners opposing the side illustrated in FIG. 1E.

FIG. 1G provides an isometric view of the frame of the embodiment of FIG. 1A.

FIG. 2 provides a view of an embodiment of the control panel.

FIG. 3A is a detailed view of one side of the heating and/or cooling device of the embodiment of FIG. 1A.

FIG. 3B is a detailed view of the side of the heating and/or cooling device opposite from the side illustrated in FIG. 3A.

FIG. 4A is a simplified illustration of a circuitous path for temperature transfer tubing, channels, or grooves in a cushion of a pet bed for circulating cool or warm air in accordance with an embodiment.

FIG. 4B is a simplified illustration of a path for temperature transfer tubing, channels, or grooves in a cushion of a pet bed for circulating cool or warm air in accordance with an embodiment.

FIG. 5 is a side view of an embodiment of a frame including a channel through which cooled or heated air is blown on the pet.

FIG. 6A is an isometric view of a pet bed according to an embodiment.

FIG. 6B is a top view of a pet bed according to an embodiment.

FIG. 6C is a side view of a pet bed according to an embodiment.

FIG. 6D is an illustration of a pet bed with a removable cushion and a control panel for a temperature regulation device according to an embodiment.

FIG. 7A is an illustration of heat transfer grooves combined with a temperature regulation device in a cushion of a pet bed according to an embodiment.

FIG. 7B is a cross-sectional view of a heating or cooling device enclosed in plastic with heat transfer grooves.

FIG. 7C is an illustration of a heat transfer groove combined with a temperature regulation device in a cushion of a pet bed according to an embodiment.

### DETAILED DESCRIPTION

The following describes portable heating and/or cooling beds for pets. The details included herein are for the purpose of illustration only and should not be understood to limit the scope of the disclosure. Moreover, certain features that are well known in the art are not described in detail in order to avoid complication of the subject matter described herein.

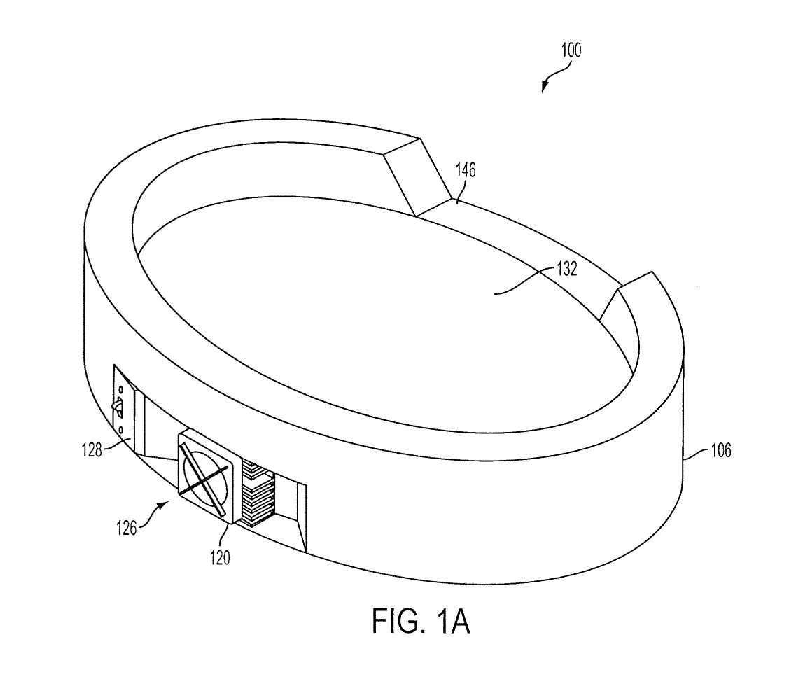

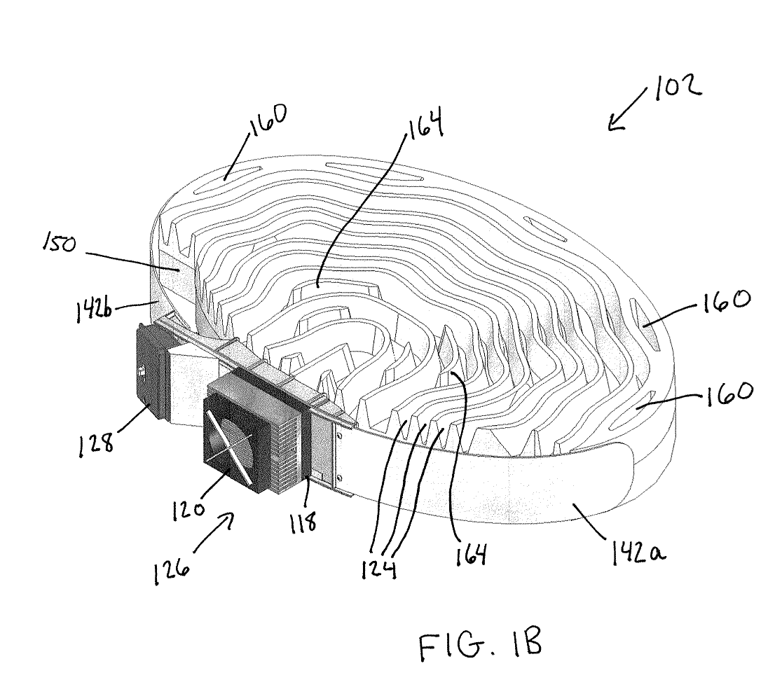

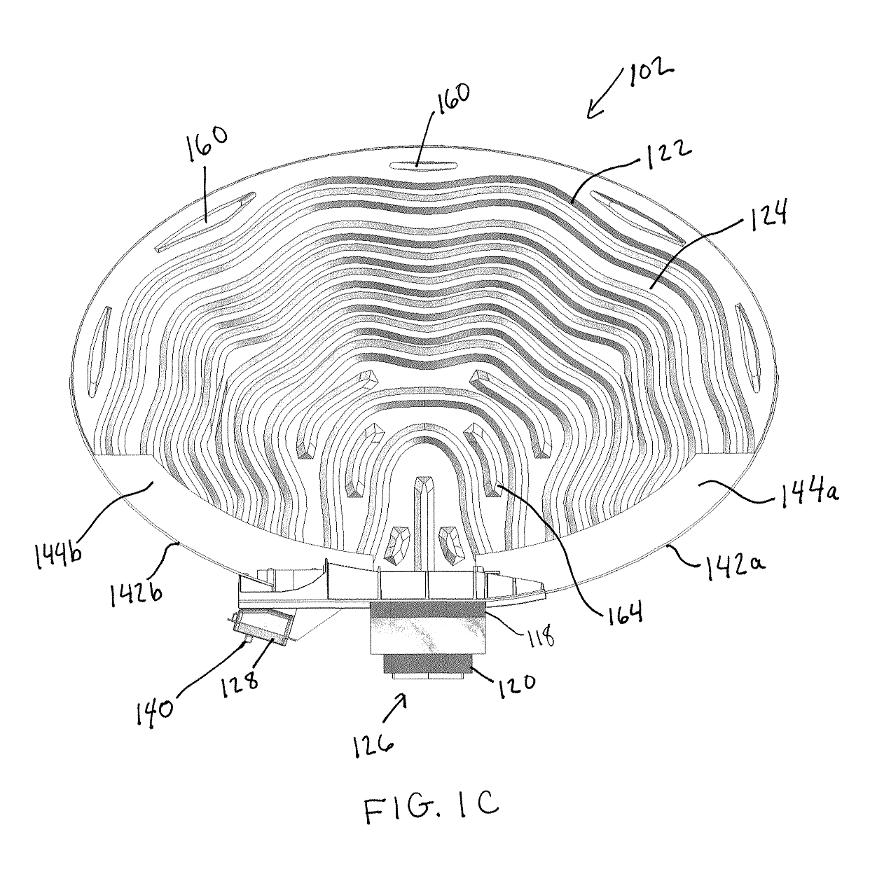

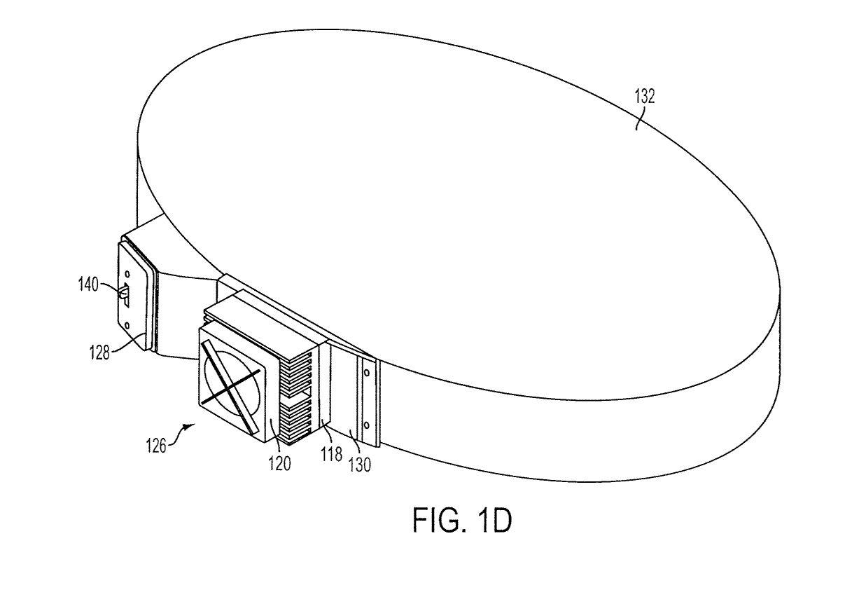

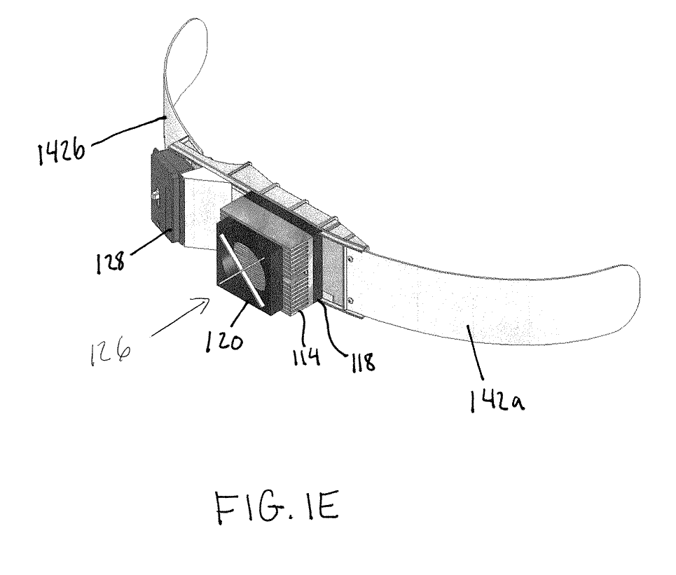

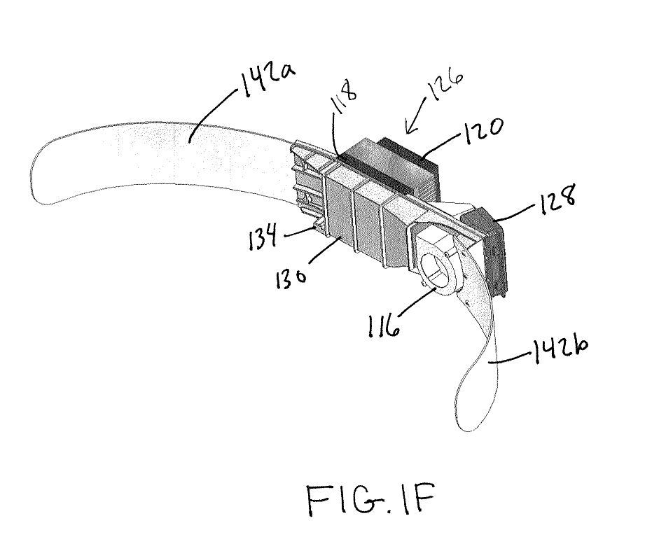

An portable heating and/or cooling pad is disclosed that includes at least one temperature regulation element for altering the temperature of the pad. FIGS. 1A-H illustrate an embodiment in which pet bed 100 includes a channeled cushion 102. The assembled pet bed 100 of this embodiment is shown in FIG. 1A. FIG. 1B provides an isometric view of channeled cushion 102 and FIG.1C provides a top view of channeled cushion 102. In this example, walls 122 form concentric, arcuate channels 124 within channeled cushion 102, although the particular shape of the walls can be modified without departing from the scope of the invention. The channels 124 are open to plenums 144a and 144b. As illustrated in FIG. 1B, the outermost wall may optionally include cut-outs 160 for providing flexibility and consistency in texture to the channeled cushion 102. Additionally, the channeled cushion 102 may include support walls 164 for providing extra support. To provide further cushioning, a second cushion 150 may be included underneath channeled cushion 102.

As illustrated in FIG. 1D, channeled cushion 102 may include a covering comprising a piece of fabric or netting (not shown), which may include but is not limited to plastic, nylon or cloth netting, or a microfiber material with a waterproof underlayer. The fabric or netting may allow circulated air to penetrate and escape to the surface, to heat or cool the animal directly. Preferably, the fabric or netting may be air tight or resistant to air penetration, to provide indirect heating or cooling. As a further embodiment, the fabric, netting or other surface material can include a conductive element for transporting heat energy to or from the surface. Preferably, the covering is antibacterial, stain resistant (TEFLON), chew resistant, and/or anti flea.

With regard to FIG. 1C, walls 122 and support walls 164 can be made of any material stiff enough to prevent the walls from completely collapsing under the weight of an animal, but soft enough to deform a bit and be comfortable for an animal to lie on. This material may include but is not limited to foam urethane. The wavy shape and the triangular cross-section of walls 122 further prevent walls 122 from completely or partially collapsing under the weight of an animal. Other shapes may be used to achieve the same objective. To further prevent walls 122 from collapsing, the fabric covering the channeled cushion 102 may be attached to the tops of walls 122 such that the distance between the channels is maintained.

Alternatively, channeled cushion 102 may be made of a firm material, such as plastic, that retains its shape when sat upon by an animal. Additionally, the covering may include padding to provide a comfortable seating surface.

Stiffeners 142 may be included to trap air conditioned by the heating and/or cooling device 126 within the cushion 102. Stiffeners 142a, 142b define a sidewall of plenums 144a, 144b. Stiffeners 142a, 142b hold the fabric covering cushion 102 taut so that the fabric does not droop into channels 142 or plenums 144a-144b.

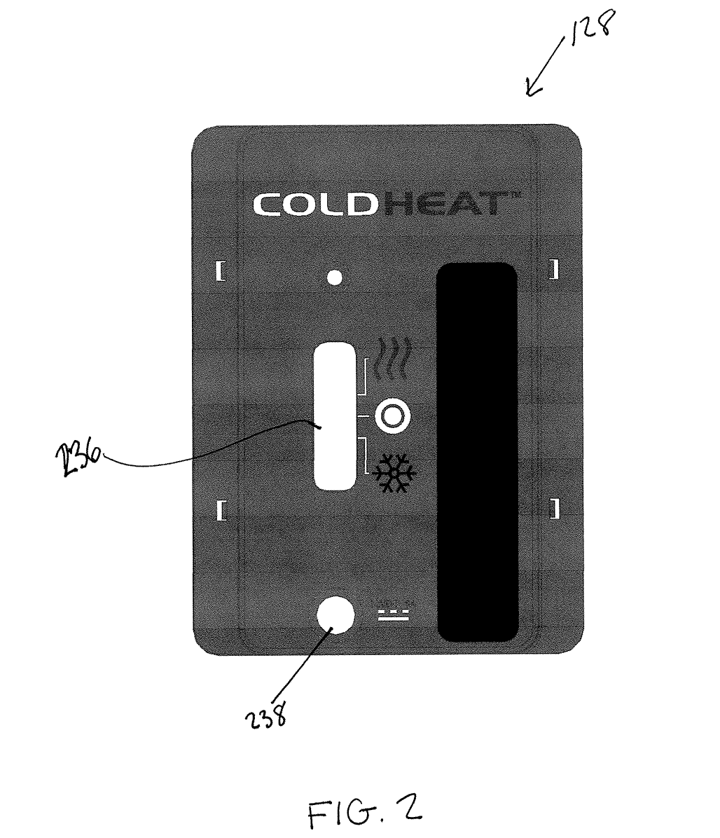

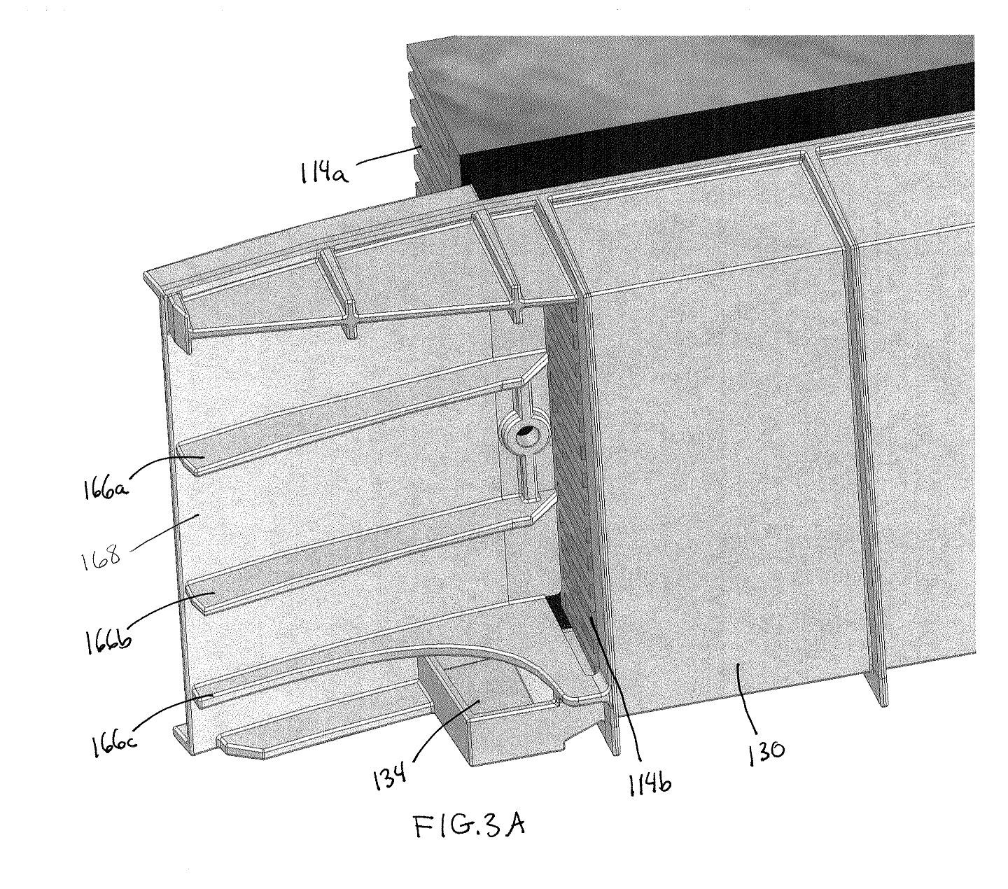

FIGS. 1E and 1F illustrate components of the heating and/or cooling device of FIG. 1A, including a Peltier device 126, a duct 130, a circulating fan 116, and a cooling fan 120. Peltier device 126 can be used to provide heating and/or cooling. Any thermoelectric heater or cooler could be used. Peltier device 126 includes Peltier element 118 and may include heat sinks 114a, 114b. Peltier device 126 is proximate to channeled cushion 102 so that Peltier device 126 can heat or cool channeled cushion 102. In FIGS. 1A-1F, one heat sink 114a is exposed and the other heat sink 114b (FIG. 3A) is located inside duct 130. During cooling, Peltier element 118 is heated on the side adjacent to one heat sink and cooled on the side adjacent to the opposing heat sink. Heat sinks 114a, 114b may be used to intensify the heating and cooling, respectively. During operation, circulating fan 116 blows air through channels formed by fins of heat sink 114b located within duct 130. In some embodiments, the surface of Peltier element 118 adjacent duct 130 defines a wall of duct 130.

When used as a cooler, air transport fan 120 dissipates the heat from Peltier device 126 to prevent Peltier device 126 from overheating. Heat sink 114b located within duct 130 is protected from ambient air. In operation, circulating fan 116 blows air past heat sink 114b so that the air is cooled and blown through plenum 144a and through channels 124, which direct the air back around through a plenum 144b and into circulating fan 116 to be re-cooled and re-circulated through the channels 124. As the cooled air blows through channels 124, it cools the pet lying on top of cushion 102. In this example, circulating fan 116 is a centrifugal fan oriented vertically. However, circulating fan 116 may be oriented horizontally or in any other position necessary to blow air past heat sink 114b. Circulating fan 116 is not limited to being a centrifugal fan.

FIG. 1G provides an isometric view of frame 106, which has a low portion 146 for allowing the pet to easily enter the pet bed 100. Opening 148 provides a space for the heating and/or cooling device 126. Frame 106 includes a base portion 101 and a wall portion 103. Frame 106 may be covered in the same material or a different material from the channeled cushion. The bottom of frame 106 may include a gripping surface. Frame 106 may be made from foam urethane, plastic, or any other material sufficient to provide support around channeled cushion 102 and to protect the heating and/or cooling device. Frame 106 is shown as being oval. However, frame 106 may be rectangular, u-shaped, or any other shape. It is contemplated that the cushion 102 could be used without frame 106. When the cushion 102 is used alone, a small padded or rigid cover (not shown) may be included for protecting the heating and/or cooling device 126 and/or the control panel 128.

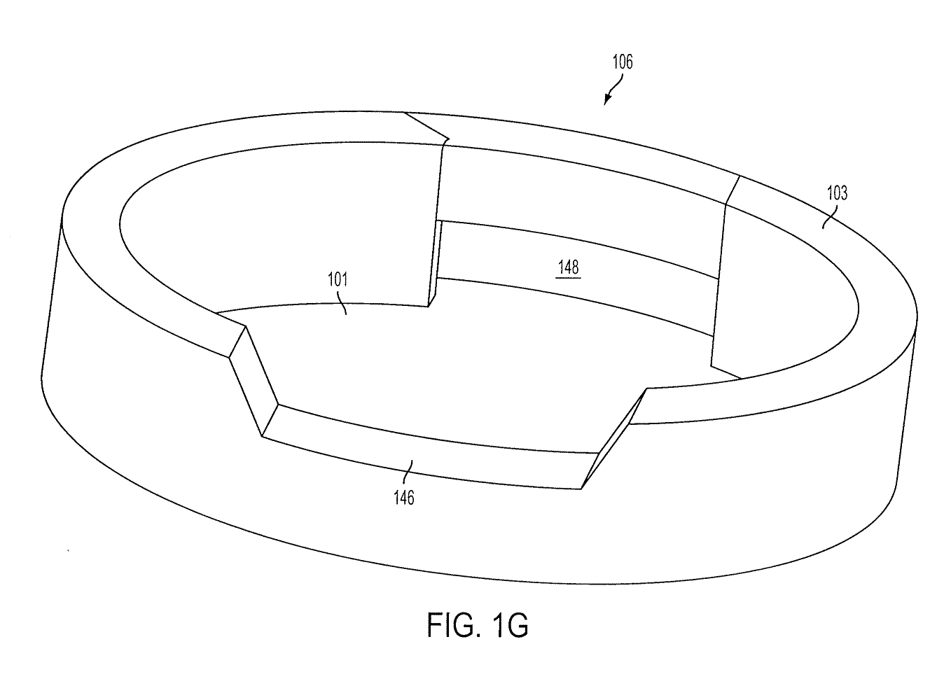

With regard to FIG. 2, a control panel 128 may be provided adjacent the heating and/or cooling device 126 or elsewhere on or near the pet bed. Control panel 128 may be included in other embodiments of the pet bed. Detail of control panel 128 is illustrated in FIG. 2. Hot, cold, and off settings are provided adjacent a switch slot 236, through which a switch 140 protrudes. Control panel 128 provides a power cord input 138 for plugging the power cord into the pet bed 100.

FIGS. 3A and 3B provide a detailed view of duct 130, including optional condensation collector 134. An opening 136 in duct 130 provides communication between the collector 134 and heat sink 114a. A wick end (not shown) is inserted into collector 134 so that the wick is positioned near heat sink 114a which provides warm air that dries the wick when the heating and/or cooling device 126 is operating to cool the pet bed 100. As illustrated in FIG. 3A, an inner wall 168 of duct 130 includes fins 166a-166c that provide further heat transfer from the air flowing through duct 130. Fin 166c prevents air flowing through the duct from escaping through opening 136.

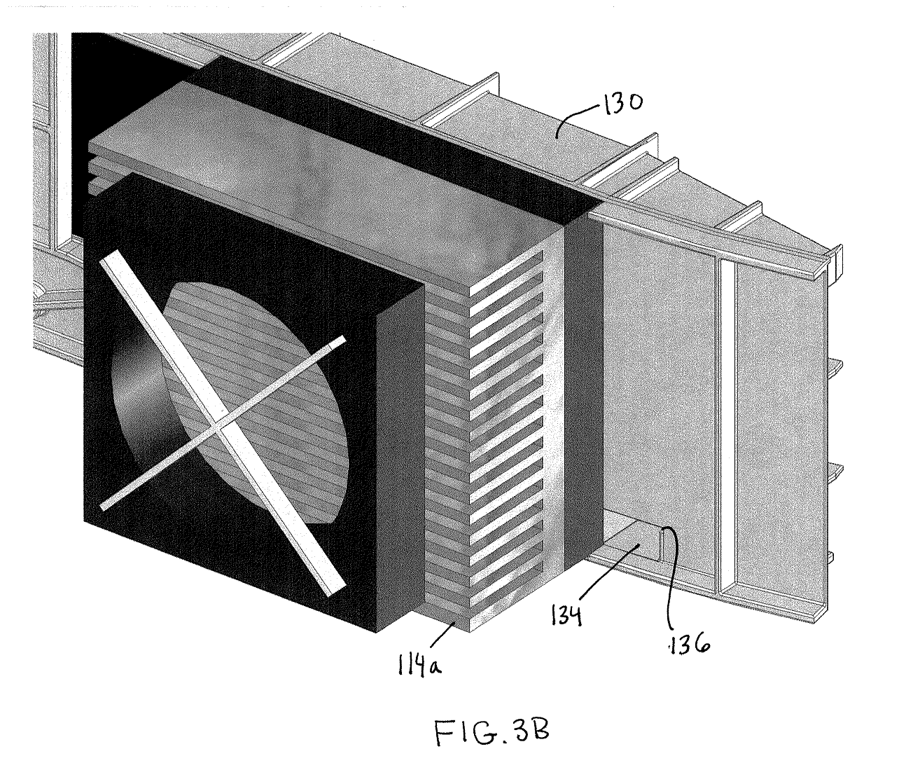

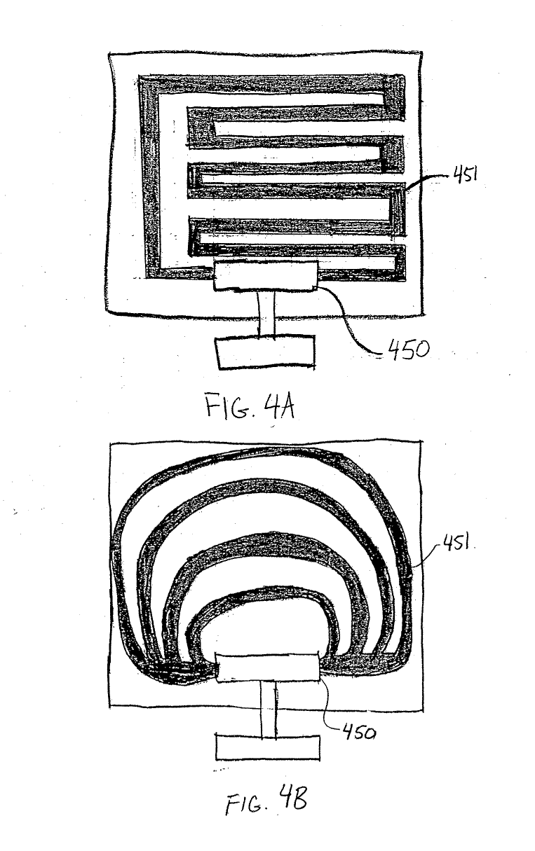

In other embodiments, as illustrated in FIGS. 4A and 4B, a heating or cooling device 450 includes a fan (not shown) and contiguous tubing or a cut-out/etching within a pad to form a channel 451 or channels (not shown). Air is re-circulated through channel 451 to maintain a cool or warm temperature. The cut-out portions within the padding may be supported by netting or a net covering so as to facilitate the return to the original shape of the channel after being compressed by an animal resting upon it. A netting or net covering may be attached to the top of the pad so that the spacing of the channels is maintained, which prevents the channels from collapsing. The process of etching or channeling the circuitous path may be performed by dividing the padding into several layers, each with a net covering. Integration of a conditioner into the pattern is also a feature.

FIG. 5 illustrates a pet bed 500 having a base portion 507 and a wall portion 505. Wall portion 505 includes a duct 541 that allows temperature-adjusted air to blow on a pet resting on the bed. The embodiment of FIG. 5 further provides a channel 501 that enables dissipation through outlet 502, which is located on base portion 507. For example, heat may be dissipated when a Peltier device 503 is operating as a cooling element. A pad (not shown) may be included on top of base portion 507. Base portion 507 and wall portion 505 may be formed of any desired shape. Wall portion 505 may completely surround base portion 507 or only surround a portion of base portion 507. It is contemplated that a plurality of channels 501 and ducts 541 may be included. FIG. 5 illustrates the use of optional fins 55. Ducts and channels may include a round or rectangular passage with a fan to force air through the passage to facilitate heat transfer with fins. Fan will force warm or cool air to blow on a pet resting on pillow. It is also contemplated that more or fewer ducts or ducts of alternate shapes and sizes may be included and may be located anywhere throughout a pet bed including a pillow. In an alternative embodiment, the bed may include a “roof” portion to create a closed-in “den” effect, which may be appreciated by canines. This roof portion also can be retractable or otherwise removable by a zipper, Velcro, or any other means.

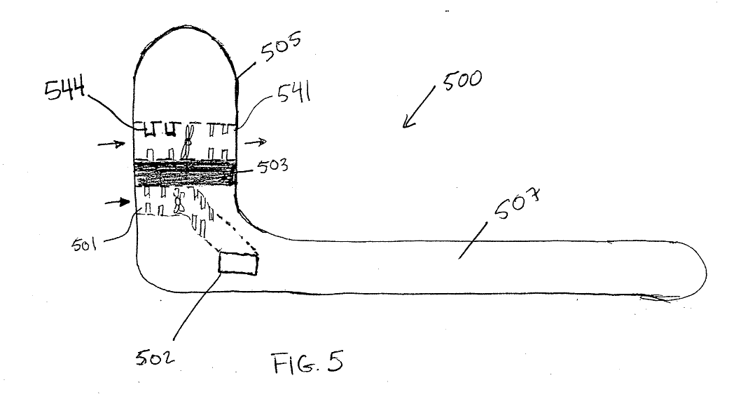

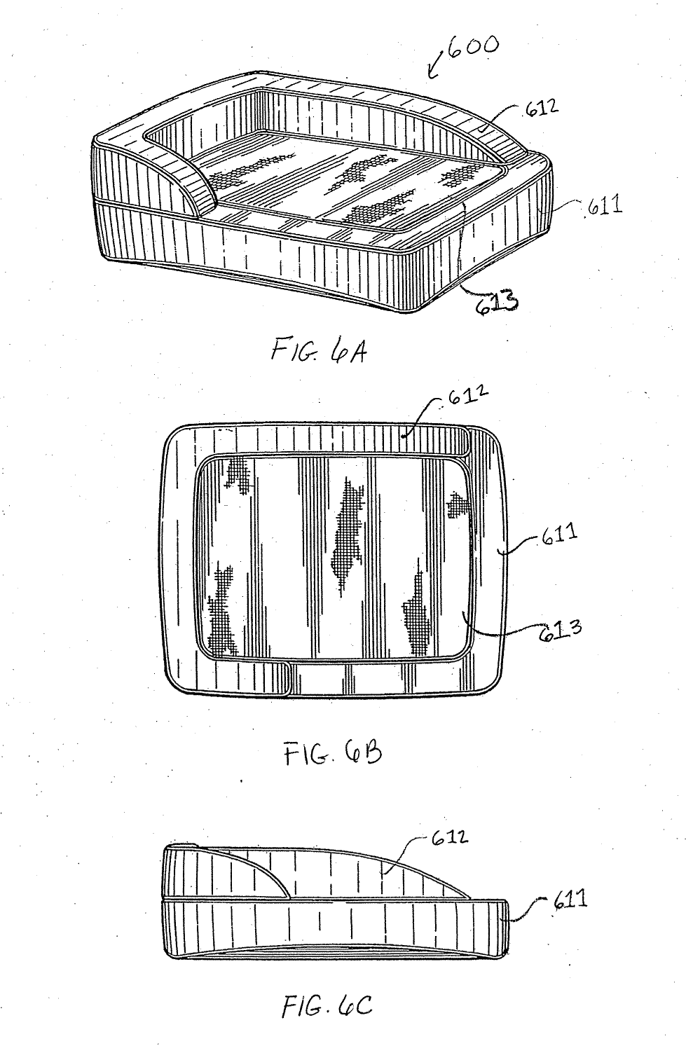

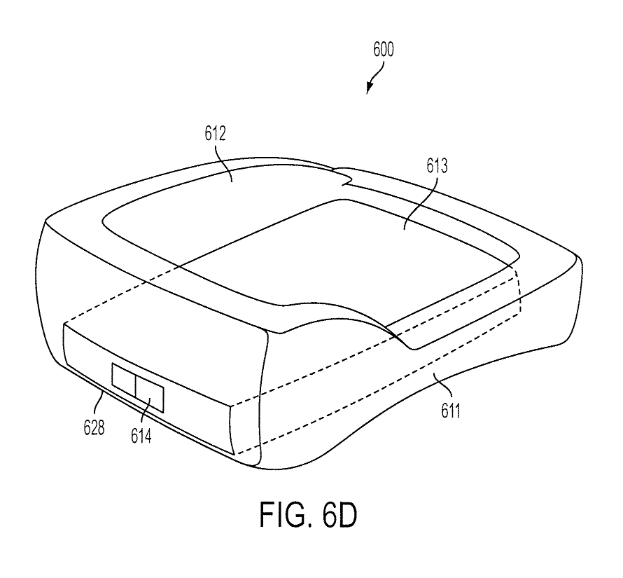

FIG. 6A provides an illustrative isometric view of a portable pet bed. FIG. 6B and FIG. 6C provide a top view and a side view, respectively, of a portable pet bed. FIG. 6D provides an isometric view that includes the opposite side of the pet bed. Control panel 628 is provided on a front side of the bed 600. While only location or placement is shown for various units, such as the control panel, variations are possible. It is further understood that various cooling and heating configurations disclosed may be used with this embodiment.

In FIG. 6A, frame 611 provides a structure for the pet bed, which can contain any of the heating and/or cooling units described above. The frame 611 includes an upper portion 612 that rises up to provide comfort and security to a pet resting on the pet bed. Pad 613 is surrounded by frame 611 and may be removable, and in some embodiments, holds a heating or cooling plate. Frame 611, top portion 612, and pad 613 may be made from or include any suitable material. According to various embodiments, these may be made from and/or include foam and/or ballistic nylon. Such materials and those similar that are known in the art, may be used when the ambient air temperature is relatively high (e.g., during the summer time). Alternatively, for example, frame 611, top portion 612, and pad 613 may be made from and/or include fleece, imitation sheep skin, or suede material. Such material may be used, for example, when the ambient air temperature is relatively low (e.g., in the winter time). Thus, different materials may be used in order to enhance the comfort level of a pet using pad 613 (e.g., when external temperature changes make different types of surfaces desirable to the pet, or when a different pet that prefers a different type of material is to use pad 613).

Moreover, according to various embodiments, pad 613 may be constructed such that the material of frame 611 and top portion 612 may easily be changed. For example, although not shown, top portion 612 may be removably attached to frame 611 by means of, for example, buttons or a zipper. In this case, a top portion 612 made of one material may be easily replaced with a different top portion 612 made of another material (and/or having different thickness) as desired. Moreover, instead of replacing top portion 612 with another, according to various embodiments, top portion 612 may be constructed to allow the configuration of top portion 612 on frame 611 to be changed. This allows the bed to be configured in a particular arrangement that is a favorite of a pet. For example, top portion 612 may be reversible such that the top surface of top portion 612 is made of one material (e.g., nylon) and the bottom surface of top portion 612 is made of another material (e.g., suede). Alternatively, for example, top portion 612 may be reversible inside-out, such that the material on the exterior changes when the inner surface material becomes the outer surface material and the outer surface becomes the inner surface. In these, cases, top portion 612 may be removed from the remainder of frame 611, then turned upside-down or inside-out, for example, and re-attached to the remainder of frame 611. Such a reconfigurable pet bed may be extremely beneficial, for example, because it may eliminate the need for a pet owner to buy and/or store multiple top portions 612 or entirely separate pet beds (e.g., for use during different months of the year or for use by different pets).

In addition, according to various other embodiments, pad 613 may include a bottom (not shown) that is made from a different material than top. In this case, rather than having to replace or reconfigure top portion 612 as described above to provide a pet with a different type of surface on which to rest, the entirety of pad 613 may simply be turned upside-down (e.g., when it becomes colder or hotter in the environment in which pad 613 is being used) such that the top becomes the bottom and the bottom becomes the top. Thus, as with the case of a re-configurable top portion 612 described above, a pad 613 that may be turned upside-down to expose a new material to a pet may eliminate the need for a pet owner to buy and/or store multiple pads 613 (e.g., for use during different months of the year or for use by different pets). Moreover, it is contemplated that, according to various embodiments, the cooling or heating function of pad 613 described may only be used when a particular one of the two surfaces is exposed (e.g., when the warmer surface made of fleece, imitation sheep skin, suede material, or similar material is on the top).

Although not shown, pad 613 shown in FIG. 6A may also include cushion material (e.g., made from polyurethane foam or elastomer foam) or other suitable material for enhancing the comfort experience of a pet. For example, cushion material and/or other suitable material may be located below the one or more heating and/or cooling elements located in pad 613. Alternatively, the one or more elements may be positioned within, but near the upper surface of, the cushion material. It is noted that the one or more heating and/or cooling elements may be separately controlled. It is also noted that placement of cushion material or other suitable material below the one or more heating elements may, in addition to making pad 613 more comfortable, serve to reduce the transfer of heat from pad 613 to the object on which pad 613 is situated during operation. In a preferred embodiment, the cushion material is made of an orthopedic foam, of a consistency designed to protect joints and provide appropriate support to the skeletal system of a domesticated animal and facilitate a comfortable experience for a pet resting on the pad. Moreover, when pad 613 includes cushion material, according to various embodiments, the cushion material may be removable. In other embodiments, instead of foam, the pad 613 may include a soft, pliable, and re-maneuverable stuffing material to provide cushioning. Such cushioning material may include synthetic pillow stuffing such as polyester filling, or may include feathers such as goose or duck down. As a further alternative, the pad 613 may include a combination of dense foam and softer pillow stuffing. It is contemplated that different types of cushioning may be utilized for different types of animals.

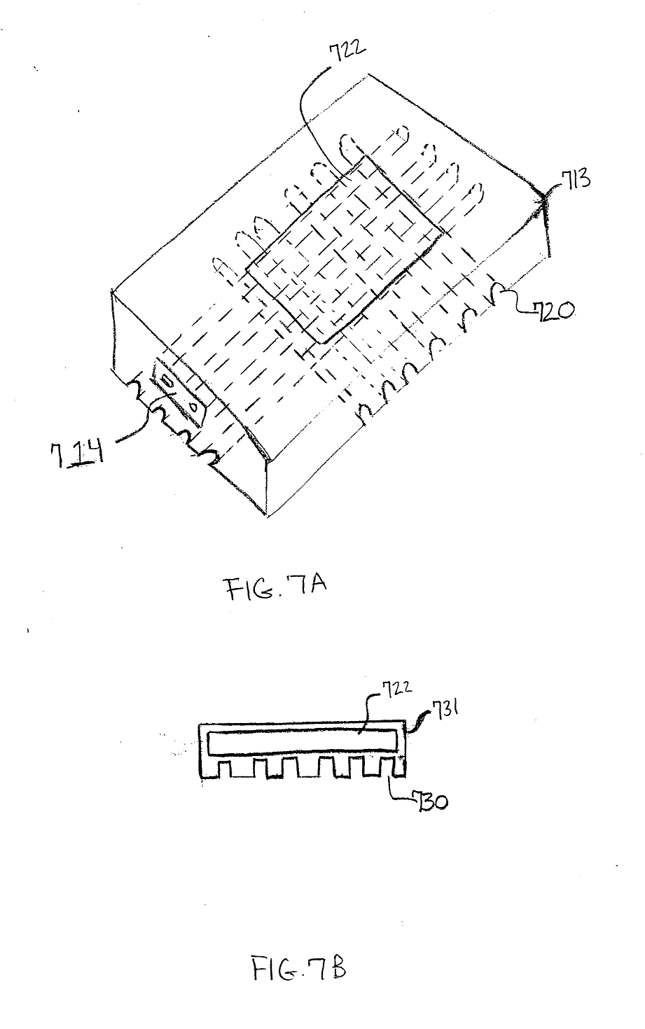

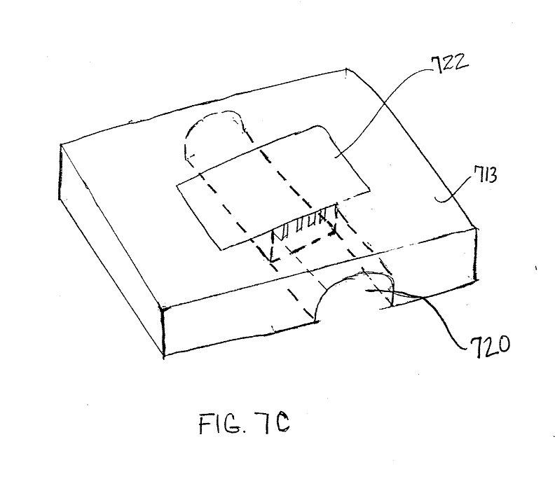

As shown in FIGS. 7A and 7B, according to various embodiments, pad 713 may house a plate 722. Plate 722 can provide heating and/or cooling of the pet bed through thermoelectric principles, e.g., as a Peltier cooler or heater. In some embodiments, plate 722 functions only as a cooling device. Heat transfer grooves 720 are provided in pad 713 to dissipate heat when plate 722 is functioning as a cooler. Alternatively, heat transfer grooves 720 disperse cold when plate 722 is functioning as a heater. As shown in FIG. 7B, plate 722 may be encased in plastic 731 or some other suitable material known in the art. Plastic 731 can be designed with heat transfer grooves 730 to work in conjunction with heat transfer grooves 720 in pad 713 through the use of cooling fins that may be part of plastic 731 or part of plate 722. In alternate embodiments, plate 722 may be multiple plates or may be divided into thermal sections that can be operated independently. In other embodiments suggested by FIG. 7C, heat transfer groove 720 is a single large groove. Additionally, the energy transfer function of groove 720 may be improved through use of a fan.

It is noted that a pad/cushion cover (not shown) may be used with any of the embodiments, and it may serve to additionally protect the control panel and/or a power source, even when one or both are situated in an external manner. When a cover is used, according to various embodiments, it may be made from vinyl or another suitable material that is able to withstand low and high temperatures, rain, moisture, and the like. Such a cover may also include one or more logos (e.g., advertisements) on the surface of the cover. it is also contemplated that the exterior of the control panel and/or a power source may be rigid and environmentally robust, such that either or both of these elements remain adequately protected even when the optional cover is not designed to cover these elements. Additionally, according to various embodiments, any cover that is being used may be removable (e.g., using a zipper or buttons), and may be machine or hand washable. Moreover, the bottom of such a cover (or pad/cushion itself) may be provided with one more gripping elements (not shown) that may be used to prevent sliding when pad/cushion is being used on a slippery surface. Additionally, pad/cushion may be used as a standalone unit, and then a power cord being used in conjunction with pad/cushion may run through an opening in the frame when pad/cushion is being used with the frame.

The pet bed may use any suitable type of power source (or a combination of more than one type of power source). For example, power may be provided to the cooling and/or heating elements of pet bed by a portable power device, such as a battery pack that includes alkaline batteries (such as “D” sized batteries), one or more lithium-Ion batteries, one or more nickel-metal-hydride batteries, and/or one or more other types of batteries. It is understood that power may be provided by an AC power outlet alone.

According to various embodiments, a battery pack being used for providing power to the one or more heating or cooling elements may be rechargeable. For example, when the battery pack is partially or completely discharged (drained of power), the battery pack may be recharged by removing it from the pet bed and placing it in a stand alone charging device that charges the battery pack using power from, e.g., an AC power outlet. In this case, a different, pre-charged battery pack may be connected to (and used to provide power to) circuitry of the cooling and/or heating device while the original battery pack is charging, thereby substantially reducing the amount of time that the cooling and/or heating device will go without power when the original battery pack is discharged. It is noted that, when a removable battery pack is used in connection with the cooling and/or heating device, this battery pack will be electrically connected to a control panel. As described below in further detail, the battery pack can be disconnected from the control panel when it is removed from the pet bed for recharging. Alternatively, the battery pack may be attached to the control panel in a manner such that the control panel is removed as well with the battery pack. The disclosure is not, however, limited in this manner.

Any type of grip or handle may be attached to the pet bed to enable a user to transport the pet bed between different locations. For example, a handle may resemble a rigid briefcase handle, a piece of string attached at two locations on a pet bed or any other suitable type of handle. As another alternative, other elements of the pad (e.g., control panel) may be used (with or without modification) as a grip or handle for transporting a pet bed between different locations. Although not shown, according to various embodiments, it is contemplated that a portion of the pet bed be extractable, where the extracted portion acets as a handle for a user for gripping.

Control panel may include an indicator light, a selector switch, a power switch, an electrical connection, or combinations thereof. Indicator light may be an LED. Additionally, additional indicator lights may be included to serve other functions, for example, to provide visual indication of the operating power level of the unit. Selector switch may be used to change the bed from heating to cooling mode (or vise versa) or select an appropriate power source (e.g., first battery, second battery, 120 V AC, car adapter). The disclosure is not limited by the types of power sources being used, or by the number of power sources being used. For example, when three power sources are being chosen from, selector switch would establish a connection between one of the three power sources, or when the heating function is to be OFF, neither of these power sources. Other configurations achieving the same result known in the art may also be used, such as multiple push-buttons or a selector slide.

In alternate embodiments, a dial may allow a pet owner to select a desired temperature for her animal and the pet bed will automatically attempt to regulate the temperature of the bed to match. For example, multiple temperature sensors are used to measure the temperature throughout the pad. A controller may use the data from these temperature sensors to adjust the temperature of the pet bed, for example through use of actuation at a set-point or a control function to ramp to the desired temperature. Moreover, an additional temperature sensor may be provided to measure the temperature of ambient air such that the temperature of the bed may be substantially maintained a pre-determined difference from ambient. Electrical connection may allow the temperature regulation features of the pet bed to function on standard 120 V AC, a vehicle power source (e.g., 12 V DC) in lieu of an internal power source. In some embodiments, while operating on an alternate power source, an internal power source, e.g. a battery pack, within the pet bed is being recharged.

In some embodiments, the control panel can include: a three position switch for selecting heating mode, cooling mode, and off; a power switch; and/or an external electrical connection port. A battery may be provided inside the pet bed and connected to the control panel with a power cord. In some embodiments, the power source or control panel may be removed without disturbing the other components. When an external power source, e.g., an AC power outlet in a home, is used to provide power to pet bed, for example, this power source may be connected to the pet bed using a connection port in the control panel. The power from the power outlet can be converted using an AC/DC converter (not shown). When an AC/DC converter is being used, it may be included with (part of) the circuitry of the pet bed or may be included with the AC power plug. Any form of connection can be used to couple the control panel to the AC outlet. When the heated pet bed is being powered by an AC power outlet, it can be appreciated that by configuring the pad to draw low current, a low voltage will be provided across the power cord, which will reduce harm should a pet chew through the power cord.

In alternative embodiments, additional features may be added to the pet bed that may work in conjunction with the control panel. For example, a sensor may be included that will determine if the bed is in use or about to be used and cause the control panel, connected by wire, to begin heating or cooling the pet bed as selected by switch. Examples of sensors include but are not limited to one or more motion sensors or infrared sensors which could detect an animal before it has even entered the pet bed allowing the bed to be more comfortable when the animal actually arrives because of the early start; one or more pressure sensors, which would register the weight of an animal on part of the bed; one or more thermal sensors, which could both indicate the presence of an animal and be used to regulate the temperature of the pet bed; one or more vibration sensors to detect entry by an animal; one or more angular (e.g., non-horizontal) positioning sensors through any suitable means of detection, including, for example, a level detector or a gyroscope, which may be used to detect when the bed is being transported and de-energize and heating or cooling elements; and combinations thereof. Multiple sensors could be used in parallel such that a pet is more likely to activate at least one when using the pet bad. Alternatively multiple sensors could be used in series to reduce the likelihood that the bed is accidentally activated.

Additional embodiments may include one or more timers to shut of the heating or cooling function if the bed is not in use to conserve energy. In some embodiments, indicator will notify an owner when a battery needs to be recharged or replaced. Instead of or in addition to indicator, an audible indication may also be provided.

Additional embodiments may also include other features for safety purposes such as fuses or flame retardant materials in the construction of the pet bed. A fuse circuit may be any suitable type of fuse circuit that is capable of providing over current protection. For example, a fuse may be designed to melt and open the circuit under abnormally high electric loads. Alternatively, according to various preferred embodiments, a fuse will operate to only temporarily open a circuit. In this manner, the triggering of fuse circuit may not require servicing of the pet bed.

A battery may be stored inside pad by means of a pouch. The pouch may have a recloseable entry mechanism such as a zipper, Velcro, or buttons. Spacing foam may be included to ensure battery remains stable and does not become disconnected when the bed in used by an animal. Additionally or alternatively, additional pouches may be added or pouch may be used to pet treats or toys. In at least one embodiment, the pouch can be sealingly opened and closed, such as with a “Ziploc” type seal, so that the pet cannot discern pet treats stored therein. In another embodiment, the pouch may include openings so that the pet can smell a scent emitted from items stored therein. This can be particularly advantageous if a pet owner wishes to insert a plant material or other chemical to induce the pet to sleep or otherwise become sedated. In a further embodiment, one or more pouches can be included in the pet bed itself, rather than or in addition to the bed frame.

Although the invention has been described and illustrated in the foregoing illustrative embodiments, it is understood that the present disclosure has been made only by way of example, and that numerous changes in the details of implementation of the invention can be made without departing from the spirit and scope of the invention. For example, it will be understood that features in one embodiment may be combined with features in other embodiments.

Moreover, it will be understood that, although the invention is described with particular attention to portable heated pads for use with pets, the invention is not limited in this manner. For example, heated pads may also be used with young children or infants, e.g., in a crib. Moreover, the concepts described herein can be extended, for example, to couches or bedding, whether portable or otherwise.

Other embodiments, extensions, and modifications of the ideas presented above are comprehended and should be within the reach of one versed in the art upon reviewing the present disclosure. For example, timer circuitry may also be used in connection with some or all of the embodiments described above. In this case, the timer circuitry may, for example, automatically deactivate (e.g., open) a circuit (regardless of the other conditions) during certain times of the day. According to various other embodiments, timer circuitry may also be used to automatically activate the circuit, regardless of the other conditions (e.g., to attract a pet by the resulting heating or cooling). Accordingly, the scope of the present invention in its various aspects should not be limited by the examples presented above. The individual aspects of the present invention and the entirety of the invention should be regarded so as to allow for such design modifications and future developments within the scope of the present disclosure.

What is claimed is:

1. A pet bed, comprising:
a cushion comprising:
a channel;
a first surface for receiving an animal lying upon the pet bed; and
a second surface opposed to the first surface;
a Peltier device located within or proximate to the cushion for heating or cooling the first surface;
a fan for blowing air heated or cooled by the Peltier device through the channel.

2. The pet bed of claim 1, further comprising a frame for receiving the cushion.

3. The pet bed of claim 2, wherein the frame comprises a base portion and a wall portion.

4. The pet bed of claim 1, further comprising a control panel.

5. The pet bed of claim 4, wherein the control panel includes a switch with heat, cool, and off settings.

6. The pet bed of claim 1, further comprising stiffeners adjacent the Peltier device.

7. The pet bed of claim 1, further comprising a plurality of channels through which air heated or cooled by the Peltier device is circulated.

8. The pet bed of claim 1, further comprising a second fan for blowing hot air away from the Peltier device when the Peltier device is cooling the first surface.

9. The pet bed of claim 1, further comprising a duct, wherein a portion of the Peltier device defines a wall of the duct and the fan blows air through the duct.

10. The pet bed of claim 1, further comprising a condensation collector adjacent a cool side of the Peltier device.

11. The pet bed of claim 10, wherein the condensation trap comprises a wick.

12. The pet bed of claim 10, wherein the condensation trap is adjacent a warm side of the Peltier device.

13. A pet bed, comprising:
a cushion comprising:
a channel having an inlet and an outlet located within the cushion;
a first surface for receiving an animal lying upon the pet bed; and
a second surface opposed to the first surface;
a Peltier device located within or proximate to the cushion;
a fan for circulating air heated or cooled by the Peltier device through the channel.

14. The pet bed of claim 13, further comprising a plurality of channels through which air cooled or heated by the Peltier device is circulated.

15. The pet bed of claim 18, wherein the cushion comprises a piece of fabric or net covering.

16. A pet bed, comprising:
a cushion comprising:
a surface for receiving an animal lying upon the pet bed; and
channels formed within the cushion by walls comprising a material sufficiently pliable to deform in response to the weight of the animal lying on the main cushion while being sufficiently rigid to withstand collapse under the weight of the animal;
a Peltier device located adjacent the main cushion, wherein the Peltier device cools or heats the air within the channels; and
a fan located adjacent the Peltier device, wherein the fan circulates air cooled or heated by the Peltier device within the channels.

17. The pet bed of claim 16, wherein the walls have a substantially triangular cross-section.

18. The pet bed of claim 16, wherein the walls are substantially wavy-shaped.

19. The pet bed of claim 16, wherein the walls are substantially concentric.

20. The pet bed of claim 16, further comprising a second cushion, wherein te first cushion is above the second cushion.
